(19) United States
(12) Patent Application Publication
(10) Pub. No.: US 2019/0126382 A1
(43) Pub. Date: May 2, 2019

(54) ELECTRODE HOLDER FOR EASY WEAVING MOTION

(71) Applicant: Taekjoon Kim, Chungcheongnam-do (KR)

(72) Inventor: Taekjoon Kim, Chungcheongnam-do (KR)

(21) Appl. No.: 16/095,658

(22) PCT Filed: Aug. 3, 2017
(86) PCT No.: PCT/KR2017/002495

§ 371 Date: Oct. 22, 2018

(30) Foreign Application Priority Data
May 10, 2016 (KR) 10-2016-0056978

(51) Int. Cl. B23K 9/30; B23K 9/28; B23K 9/32; B23K 31/02; B23K 37/00

(52) U.S. Cl. CPC B23K 9/30; B23K 9/28; B23K 37/00; B23K 31/02; B23K 9/32

(57) ABSTRACT

The present invention provides a welding rod holder for easy weaving motion, comprising: a main body part including a case, and a driving handle driving a driving part while being installed in the case; the driving part installed in the main body part, including a driving motor, a small bevel gear rotating while being connected to a driving shaft of the driving motor, and a large bevel gear rotating at a reduced speed while being connected to the small bevel gear in a perpendicular direction; a weaving part formed to be connected to the driving part including a weaving frame where an installation space is formed inside, a slider fixated by being connected to one plane of the weaving frame, a protrusion and a groove formed in turn on both sides and an upper protruding bar and a lower protruding bar separated from each other formed to protrude in the installation space and moved up and down by adhering to a rotating sphere, and the rotating sphere eccentrically connected to a close point close to a center of the large bevel gear through an axis rotating in a state of adhering to the upper and lower protruding bar; and an operation part including a center rod installed in the case in a forward and backward direction and connected to a cable and installed with a welding rod, a pair of circular plates formed on the center rod located in the case while being separated from each other, and a saw-toothed wheel formed on each circular plate making the center rod rotate from side to side by being geared with the slider.

### FIELD OF INVENTION

The present invention relates to a welding rod holder, and more particularly to a welding rod holder that is capable of easily implementing a weaving operation, by controlling the speed of left and right rotation and the momentum of the back and forth movement for efficient welding for improving productivity.

### BACKGROUND TECHNOLOGY

In general, a arc welding is a type of welding for joining metal to metal, by an arc heat generated between the metal base material and the electrode for melt-bonding of metals. A welding electrode is used as the electrode. An arc is the arc-shaped flame with a strong light and high heat by the discharge when the tip of the welding rod is lightly contacted with the metal base material. And the arc heat is used to melt the welding portion of the metal base material, and then the volume of the sparing material is welded to the weld portion, for joining them together.

In order for these joints to be welded well, the welder must learn the high-level of weaving motion. This weaving motion is not only a simple moving in lines or curves but also moving to and fro, from side to side, like a pendulum with respect to the welding direction, in order to increase the amount of welding by a single path movement when welding. Sometimes it requires a high level of sophisticated technology, like using a long chopstick tip to pick up a needle and sew it. If the welder does not learn such weaving operation and performs welding, metal base material will sink and cause undercut. Or the weld metal ends do not fuse with the base material, and overlap, i.e., the state of being protruded occurs, leading to cracks, and various welding defects such as incomplete penetration.

Analysis of the weaving motion based on the directional element shows the left and right motion of swinging the end of the welding rod and the back-and-forth movement of the welding rod tip. By combining these two moments appropriately, the resulting weaving motion has the shape, such as a half-moon, a shell, and an English handwriting letter a to obtain satisfactory welding results. However, since the length of the welding electrode is long and appropriate combination of welding position, the proper amperage, and travel speed is crucial for welding, only experts can obtain good welding results, that is a big problem in welding.

In the prior art, Patent Document 1 discloses a welding rod holder for an arc welder comprising; a bar type handle, made of an insulating material, and a socket coupled to a side of the handle to fix the welding rod, a rod connector, inside the handle, having a function of controlling a welding electrode coupled to a socket while supplying power necessary for welding, the rod connector including a bar type connector body, a coupling bar which can be coupled to a coupling hole formed at the rear of the connector body and includes a threaded portion formed so as to be able to be coupled with a socket on the side of the connector body, and a socket including core material made of a metal material and provided in a bar type having a screw hole for engaging with a threaded portion of the rod connector, and an insulator material cap, sealing the tip end face of the core, and a welding rod hole, formed at front end faces of core and rod connector and at an eccentric position relative to the center of the socket and the load connector, to allow horizontal connection of the electrode in the axial direction of the core and the rod connector, and a welding rod coupled to the welding rod hole controlled with the eccentricity of the core and the rod connector by rotation of the socket with respect to the rod connector.

However, the welding rod holder according to the above-described conventional technique is not suitable for rotating the welding rod holder while welding, due to its long structure. In the case of argon welding, since the distance between the wrist and the base material is short, the welder uses the half-moon shape weaving by the wrist to make a bead according to the left-right rotation motion, which may cause the wrist joint problem.

Therefore, the welding rod holder according to the above-described prior art has a problem that it is difficult to obtain a good welding result, because there is no recipe for the weaving operation, and a large deviation of the welding result occurs according to the skill of the operator.

### PREVIOUS ART

### Previous Patent

(Patent Document 0001) Korean Utility Patent Registration No. 20-0376530 (published on Mar. 9, 2005)

### DESCRIPTION OF INVENTION

### Technical Problem

The present invention has been conceived to solve all of the problems described above, and it is possible to easily implement the weaving operation by separately applying the two moments of the left-right rotation movement and the back-and-forth reciprocating motion, and it is possible to improve the weld bead qualitatively by adjusting the speed of the left and right rotation motion and to improve the quantity of welding bead by adjusting the momentum of the reciprocating motion in the forward and backward directions. Therefore, it is possible to easily produce a new weaving operation for realizing defect-free welding and since all welding is possible by one-pass welding, efficient welding is possible for improved productivity.

In addition, the training period for the welding worker is greatly shortened because of no need of master training such as the welding posture, the welding tips and the weaving operation, and it is possible to reduce the fatigue and injury of the worker due to the convenient welding work. The objective of the present invention is to make it possible to carry out the welding without difficulty even in the case of overhead position welding and thin stainless steel welding.

### Solution to the Problem

According to an aspect of the present invention to solve the above problem, there is provided a welding rod holder for easy weaving motion comprising: a main body including a case and a driving handle provided on the case and driving the driving unit; A driving unit installed in the main body and including a driving motor, a small bevel gear connected to the driving shaft of the driving motor, and a large bevel gear connected in a direction perpendicular to the small bevel gear to rotate at a reduced speed; a weaving part formed to be connected to the driving part including a weaving frame where an installation space is formed inside, a slider fixated by being connected to one plane of the weaving frame, a protrusion and a groove formed in turn on both sides and an upper protruding bar and a lower protruding bar separated from each other formed to protrude in the installation space and moved up and down by adhering to a rotating sphere, a weaving part, eccentrically connected to an adjacent point on an axis close to the center point of the large bevel gear, including a rotator rotating in close contact with the upper and lower protruding bars, a center rod installed in the case in a forward and backward direction and connected to a cable and installed with a welding rod, a pair of circular plates formed on the center rod located in the case while being separated from each other, an operation part including a saw-toothed wheel formed on each circular plate making the center rod rotate left and right by being geared with the slider.

In addition, in the present invention, the weaving part further includes a front-backward reciprocating bar mounted inside the mounting space and formed in a shape of “ [symbol] ”, and when the reciprocating adjusting handle provided on the case is operated, the front and back reciprocating bar descends in the mounting space, and the slider fixed to the weaving frame reciprocates forward and backward to exert a force on the pair of discs to reciprocate forward and backward of the center bar.

In this case, the front and rear reciprocating bars can be formed such that both sides of the reciprocating bar are gradually tapered toward the lower side.

In addition, the case is provided with a reciprocating adjustment handle, and the reciprocating adjusting handle is connected to the front and rear reciprocating bar through wires having elastic springs at both ends thereof, and the amount of reciprocation of the center rod can be adjusted by adjusting the degree of the reciprocating bar being lowered.

In addition, the case may be fixedly coupled to a base plate, and the base plate may be provided between the slider and the center bar, and the slider can be vertically movable while sliding on the base plate.

Furthermore, the case is provided such that a fixture having a spring on the top thereof is exposed to the outside, and the projecting portion and the groove portion are alternately formed in the middle part of the center bar. When the above fixture clamp is depressed, the lower end of the rounded portion is in contact with the middle portion of the center rod, fixing the center rod.

### Effects of this Invention

According to the present invention, it is possible to easily implement the weaving operation by separately applying the two moments of the left-right rotation movement and the back-and-forth reciprocation movement, and it is possible to improve the qualities of the weld bead by adjusting the speed of the left and right rotational motion and to increase quantitatively the weld bead by adjusting the momentum of the forward and backward reciprocating motion. As a result, the new weaving operation can be easily made to realize defect-free welding, and all the welding can be performed by one-pass welding, so that the productivity can be improved by efficient welding.

In addition, the training period for the welding worker is greatly shortened because of no need of master training such as the welding posture, the welding tips and the weaving operation, and it is possible to reduce the fatigue and injury of the worker due to the convenient welding work. There is also advantages that it can be carried out without difficulty from a horizontal posture welding to the high level of sophisticated welding, such as the overhead position welding and the welding of the thin stainless steel.

### BRIEF DESCRIPTION OF DRAWINGS

FIG. 1 is a side view of a welding rod holder according to an embodiment of the present invention.

FIG. 2 is a view illustrating a driving unit according to an embodiment of the present invention.

FIG. 3A is an exploded perspective view of a weaving part according to an embodiment of the present invention, and FIG. 3B is an assembled perspective view of a weaving part according to an embodiment of the present invention.

FIG. 4 is a view showing an operation part according to an embodiment of the present invention.

FIG. 5 is a circuit diagram showing an operation of the driving knob according to the embodiment of the present invention.

FIG. 6 is a state diagram illustrating a left-right rotational motion according to an embodiment of the present invention.

FIG. 7 is a state diagram showing a front-back reciprocating motion according to an embodiment of the present invention.

### DETAILED DESCRIPTION OF THE INVENTION

Hereinafter, with reference to the drawings, specific details of an embodiment of an electrode holder, i.e., welding rod holder capable of easily performing weaving operation according to the present invention will be described in detail with reference to the embodiments.

In general, beginners who do welding do not know well what kind of shape they are in now because the molten material in the bead is completely covered in the slag during welding. Therefore, even if the selection of the speed control and weaving operation of the electrode is good, neat welding results are not obtained. Even if good welding results come out accidentally, retrying will result in defective welding results.

More specifically, if welding is performed in a horizontal posture, the welding field is dark. Therefore, even if the welding rod is excessively melted and the molten material flows, a novice worker may not know its cause, whether it is due to the improper amperage or due to the low travel speed, and whether it is molten material or slag that flows down. In addition, the novice worker is not well aware that the sounds, smoke, smell, and other senses felt by the various welding conditions are important factors in acquiring excellent welding skills and know-how. Furthermore, the biggest obstacles to mastering welding technology are sparks (spatter) that occur during welding and splashing in all directions, uncomfortable safety goggles, blinking due to visual impairment caused by instantaneous black out, and slag that covers the molten metal during welding, etc, hinder the correct judgement for the defects in welding results. Only after the welding is finished, the defect can be identified after the slag has been removed. Therefore, it takes a long time to learn techniques such as high-level stance welding, thin steel plate welding with different thicknesses, and stainless steel welding, etc., because it is difficult to transfer technology to beginners during the training, and it takes a long time.

However, if the welding rod holder 1 having a simple weaving operation according to the present invention is used, when the welding is performed after the welding rod is inserted, only the intensity of the current can be adjusted so that the weaving operation can be easily implemented, and the speed of left and right rotation and the amount of momentum of back and forth reciprocation can be adjusted, so that productivity can be improved by efficient welding.

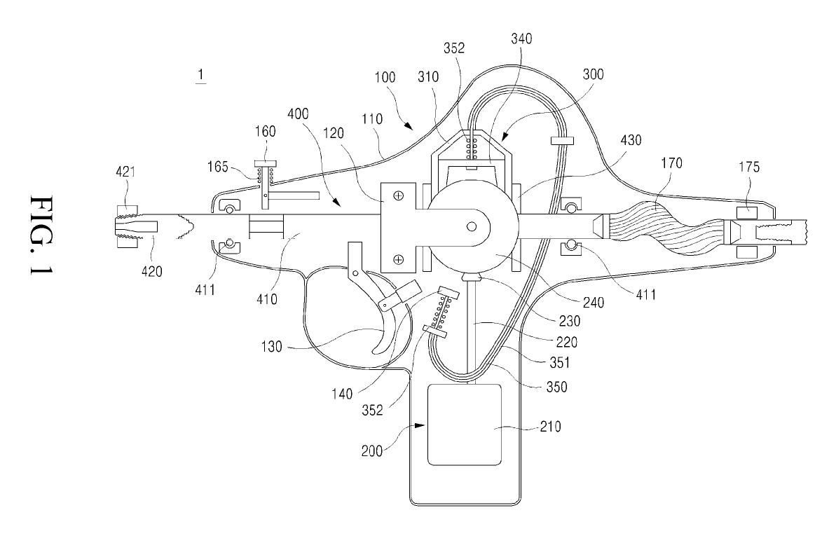

Referring to FIG. 1, the present invention mainly includes a main body 100, a diving unit 200, a weaving unit 300, and an operation part 400.

The main body 100 includes a case 110 and a fixing bracket 120 is coupled to the case 110 so that the position of the large bevel gear 240 to be described later is fixed.

The main body 100 is similar to a gun trigger so that a driving handle 130 corresponding to an electrical switch for driving the driving unit 200 is exposed to the outside of the case 110, and the handle groove 115 is formed to be pierced in the case 110 so that the reciprocating adjustment knob 140 is exposed and formed so that the driving handle 130 is adjusted by the index finger while holding the electrode holder 1 in the right hand, and the reciprocating adjustment knob 140 is adjusted with the thumb on the right-handed basis.

A flexible cable 170 is fixed to the inner rear side of the case 110 by a fixing piece 175 and is connected to an electric wire to which a current is supplied.

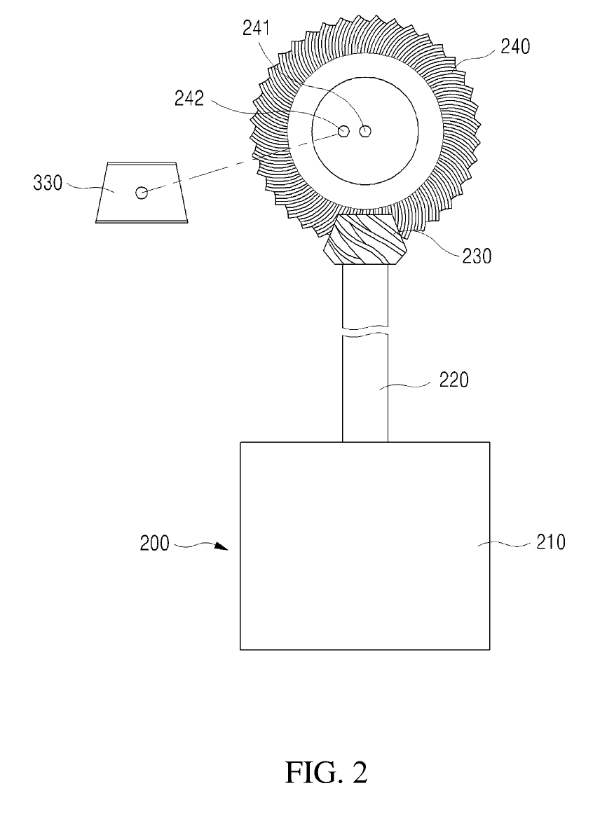

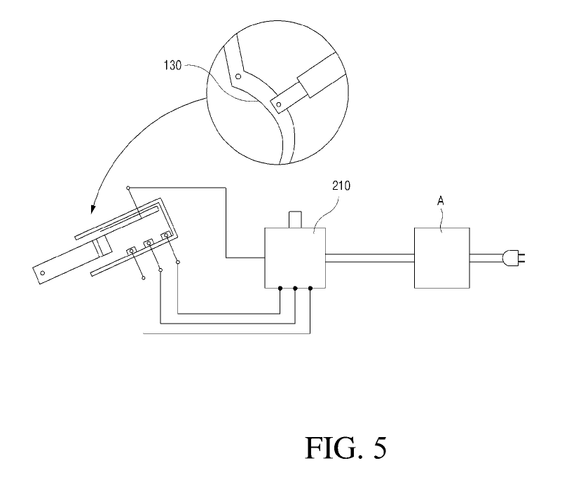

Referring to FIG. 2, the driving unit 200 is installed on the lower side of the main body 100 and includes a driving motor 210 connected to the driving shaft 220, and the speed of the driving motor 210 can be controlled in multiple stages by the driving handle 130, for example, in three steps, low speed, medium speed, and high speed. In addition, referring to FIG. 5, the driving motor 210 can prevent an electric shock and a short circuit by using an adapter A having a shielding transformer.

Furthermore, the driving unit 200 includes a small bevel gear 230 connected to the drive shaft 220 of the driving motor and a large bevel gear 240 rotating at a reduced speed in a direction perpendicular to the small bevel gear 230.

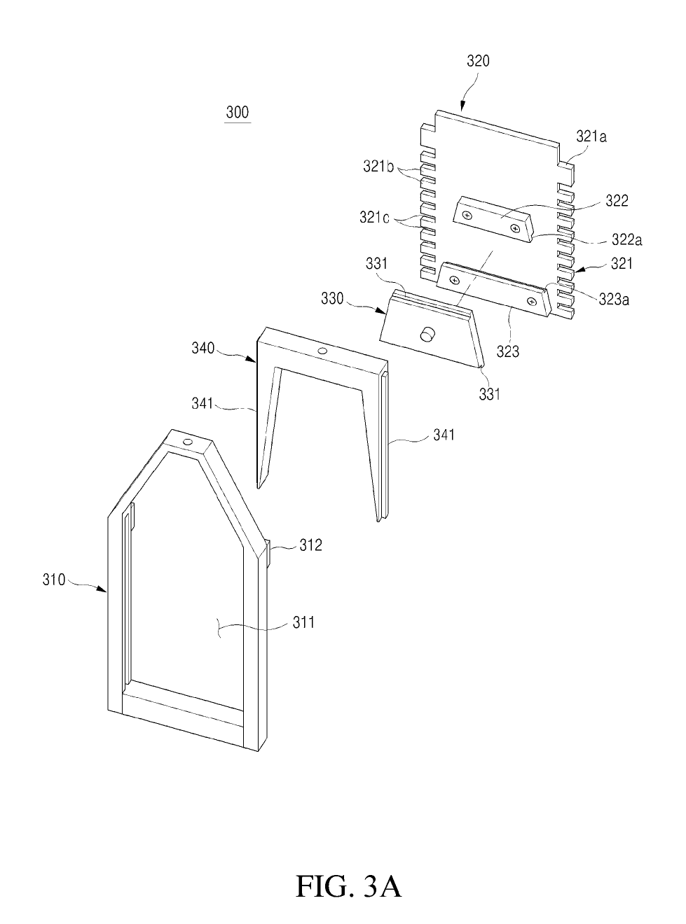

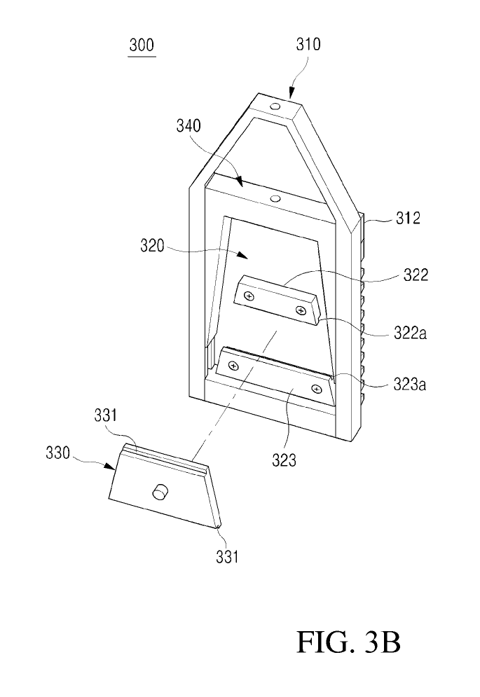

Referring FIGS. 3A and 3B, the weaving part 300 is connected to the driving part 200 to enable a weaving operation, and a plurality of bars are connected to form a hexagonal band, and a weaving frame 310 has a mounting space 311 formed therein.

A fastening piece 312 is formed on one side of the weaving frame 310, and a fastening protrusion 321a protruding from the upper end of both side portions 321 of the slider 320 is fastened to the fastening piece 312 by fastening means, and the remaining portions of the side portions 321 of the slider 320 are alternately formed with the protrusions 321b and the grooves 321c and are in contact with one surface of the weaving frame 310.

The slider 320 is provided so that upper and lower protruding bars 322 and 323 spaced from each other protrude from the mounting space 311, wherein the upper protruding bar 322 has a cut-out shape at both sides and is provided so that both side pieces 341 of the forward and backward reciprocating bar 340 can descend. In addition, the upper and lower protruding bars 322 and 323 are respectively formed with contact grooves 322a and 323a.

In addition, a rotator 330 is disposed in a space formed between the upper and lower protruding bars 322 and 323, and the rotator (330) is formed with an upper protrusion (331) and a lower protrusion (331) at the lower portion thereof to be brought into close contact with the contact grooves (322a, 323a). The slider 320 is moved up and down because the rotating body 330 is rotated while being in close contact with the upper and lower protruding bars 322 and 323 to apply a force thereto. In this way, since the rotator 330 is in close contact with the upper and lower protruding bars 322 and 323, the slider 320 can slide without moving to the outside and can move well, even if the slider 320 is erected or tilted to one side.

Here, a support plate 150 is fixedly coupled to the case 110, and the support plate 150 is installed between the slider 320 and the center bar 410. The slider 320 is vertically movable while sliding on the support plate 150 while being supported by the support plate 150.

The rotator 330 has a substantially trapezoidal shape so that when the forward and backward reciprocating bar 340 described below descends, the rotator 330 contacts the tapered portion of the forward and backward reciprocating bar 340 to apply a force thereto, and is eccentrically connected to an adjacent point near the center point of the large bevel gear 240, and is rotating in close contact with the upper and lower protruding bars 322 and 323 in the mounting space 311. However it is not in contact with weaving frame 310, but in contact with the upper and lower protruding bars 322 and 323 to move the slider 320 up and down.

The weaving part 300 has a front and rear reciprocating bar 340 mounted in the mounting space 311 and the front and rear reciprocating bars 340 are formed in a shape of “ [symbol] ”, and the both side pieces 341 extending downward are formed on both side portions.

The front and rear reciprocating bar 340 is mounted on the mounting space 311 inside the weaving frame 310 so as not to be in contact with the rotator 330. When the reciprocating adjustment knob 140 is operated, the front and rear reciprocating bars 340 are lowered in the mounting space 311 by the pushing force of the wire 350 and the elastic spring 352, and the front and rear reciprocating bar 340 reciprocates forward and backward as it is in contact with the rotating rotator 330 and receives a force.

That is, the reciprocating adjustment knob 140 is connected to the front and rear reciprocating bar 340 through a wire 353 of a good coating 351 and having elastic springs 352 at both ends and having good fluidity. At this time, when the reciprocating adjustment knob 140 is operated to push, the elastic spring 352 and the wire 350 provided at both ends are pushed and the wire 350 and the elastic spring 352 push the front and rear reciprocating bar 340, and the reciprocating bar 340 is lowered so that the side pieces 341 come into contact with the rotating rotator 330 to receive the force of reciprocating motion.

The forward and backward reciprocating bar 340 is preferably formed such that both side edges 341 are tapered in a downwardly inclined manner so that the amount of movement of the reciprocating motion can be adjusted by adjusting the degree of the downward movement of the reciprocating bar 340 through the reciprocating adjusting knob 140. That is, as the front and rear reciprocating bar 340 is further lowered in the mounting space 311, the momentum of the forward and backward reciprocation will increase.

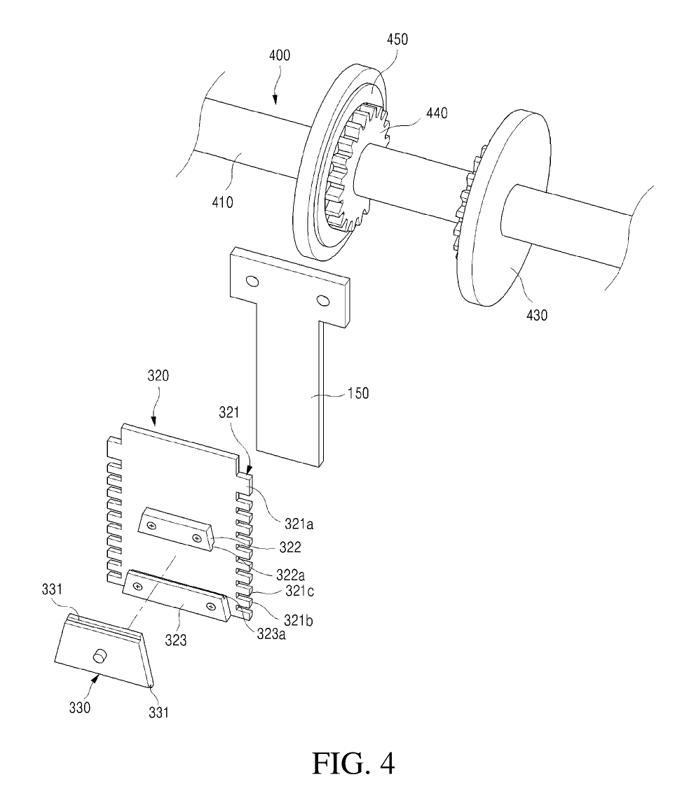

Referring to FIG. 4, the operation part 400 is actuated in accordance with the weaving operation of the weaving part 300, and a cylindrical center rod 410 is disposed inside the case 110 by a bearing 411, and a flexible cable 170 is connected to the rear of the center bar 410. A welding rod 420 is inserted and mounted on the center bar 410. At this time, the welding rod 420 is provided so that the tip end thereof is fastened by the fastener 421.

In addition, the center bar 410 located inside the case 110 is provided with a pair of discs 430 separated from each other and a gear 440 is fixed on the center bar 410 inside each of the discs 430, and the toothed wheels 440, provided with a washer 450, are engaged with the protrusions 321b and the grooves 321c of the side portions 321 of the slider 320 so that the center bars 410 are rotating right and left, and both ends of the slider 320 are brought into contact with the inner surfaces of the pair of discs 430.

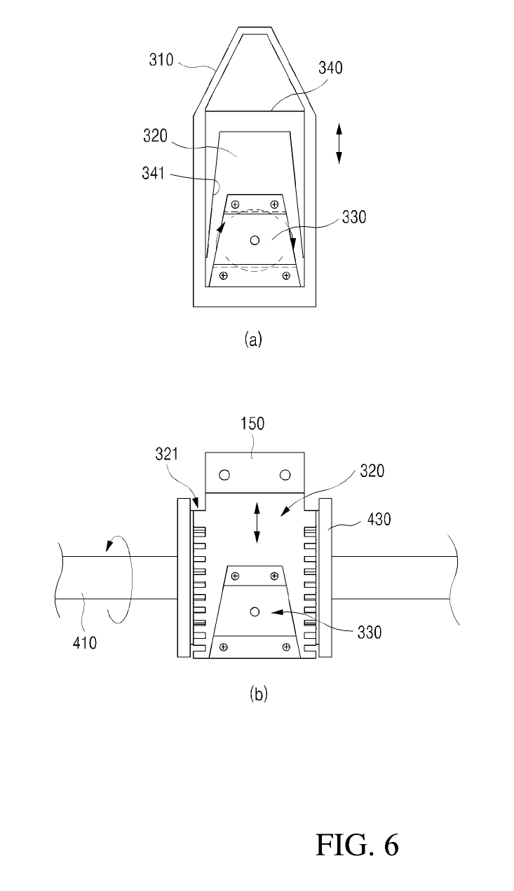

Referring to FIG. 6, the slider 320 is disposed between the upper and lower protruding bars 322 and 323, and the rotating revolver 330 is rotated together with the large bevel gear 240 to contact the upper and lower protruding bars 322 and 323 and provide a force so that the slider 320 is moved up and down and the toothed wheel 440 engaged with both side portions 321 of the slider 320 is rotated, and the toothed wheel 440 is fixedly coupled to the center rod 410 so that the toothed wheel 440 is rotated. The center rod 410 is also rotated in the left and right direction. At this time, by operating the driving handle 130, the speed may be adjusted in multiple steps. Therefore, it is possible to easily implement the weaving operation in accordance with the left-right rotation movement, and the quality of the weld bead can be improved by speed control of the left-right rotation.

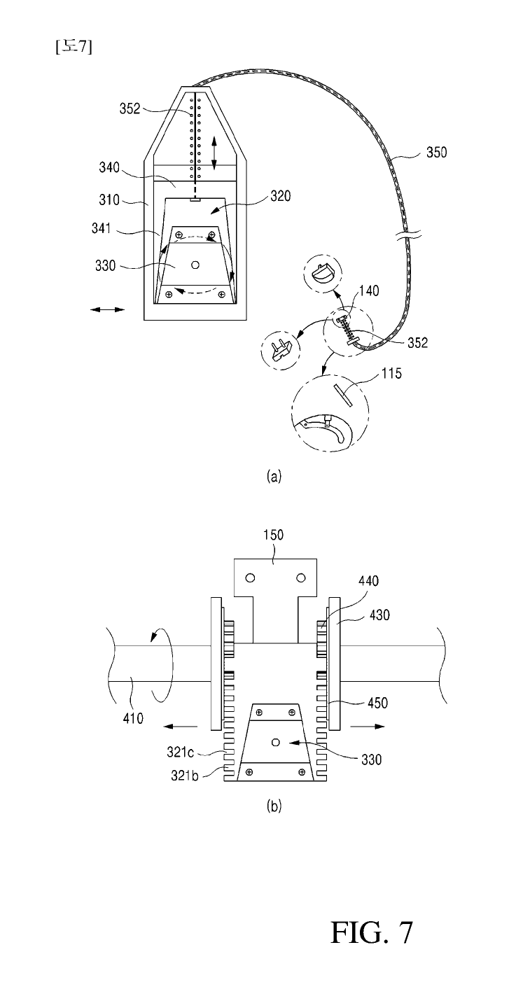

Referring to FIG. 7, when the reciprocating adjustment knob 140 is pushed and operated, the front and rear reciprocating bars 340 are moved downward in the space 311 to receive the force of the rotator 330 rotating the both sides 341, and the front and rear reciprocating bar 340 reciprocates back and forth together with the weaving frame 310. The slider 320 fixed to the weaving frame 310 is also reciprocated back and forth together with the weaving frame 310, and a force is applied to a pair of circular plates 430 which are in contact with both side ends of the slider 320, and the center bar 410 also reciprocates forward and backward. At this time, by operating the reciprocating adjustment handle 140, the amount of movement of the reciprocating motion can be adjusted. Therefore, it is possible to easily implement the weaving operation in accordance with the forward and backward reciprocating motion, and it is possible to quantitatively improve the weld bead, by controlling the moment of back-and-forth reciprocating motion.

In addition, the case 110 is installed such that a fixture clamp 160 having a spring 165 thereon is exposed to the outside, a protrusion and a groove are alternately formed at an intermediate portion of the center bar 410. When the clamp 160 is pressed, the lower end of the round bar is brought into contact with the middle portion of the center bar 410 to fix the center bar 410.

As a result, the welding rod holder 1 with easy weaving operation according to the present invention can utilize two moments of the left-right rotation movement and the back-and-forth reciprocation movement separately, and it is possible to easily implement the weaving operation. Since the quality of the weld bead can be improved by adjusting the speed of the left and right rotation motion, and the amount of weld bead can be improved quantitatively by adjusting the momentum of the reciprocating motion in the forward and backward directions, it is possible to realize defect-free welding by devising new weaving motions easily. And all welding is possible by one-pass welding, leading to improved productivity. Also, because there is no need for mastering training such as welding posture, the welding tips and weaving operation, the training period for welding workers is greatly shortened and the welding work is convenient, which can reduce the fatigue and injury of the worker. Consequently, as well as horizontal welding, it is not difficult to weld even a high degree of overhead position welding and thin stainless steel welding.

The present invention is not limited to the above-described embodiments. Anything having substantially the same constitution as the technical idea described in the claims of the present invention and achieving the same operational effect is included in the technical scope of the present invention.

### EXPLANATION OF SYMBOLS

1. Welding rod holder

100. Main body part

110. Case

115. Handle groove

120. Fixing bracket

130. Driving handle

140. Reciprocating adjustment handle

150. Support plate

160. Fixture clamp

165. Spring

170. Cable

175. Fixing piece

200. Driving part

210. Driving motor

220. Driving shaft

230. Small bevel gear

240. Large bevel gear

241. Center of large bevel gear

242. close point close to a center of the large bevel gear

300. Weaving part

310. Weaving frame

311. Installation space

312. Fastener

320. Slider

321. Both sides

321a, Fixing protrusion

321b, Protrusion

321c, Groove

322. Upper protruding bar

323a. Contact groove

323. Lower protruding bar

323a. Contact groove

330. Rotating sphere

331. Contact protrusion

340. Front and rear reciprocating bar

341. Both sides

350. wire

351. Insulation

352. Elastic spring

400. Operation part

410. Center rod

411. Bearing

420. Welding rod

421. Fastener

430. Circular plate

440. Saw-toothed wheel

450. Washer

A. Adapter

1. A welding rod holder for easy weaving motion; a main body part comprising a case and a driving handle to drive the driving part; the driving part, installed in the case, including a driving motor, a small bevel gear rotating while being connected to a driving shaft of the driving motor, and a large bevel gear rotating at a reduced speed while being connected to the small bevel gear in a perpendicular direction; A weaving part, formed to be connected to the driving part including a weaving frame where an installation space is formed inside, a slider fixated by being connected to one plane of the weaving frame, a protrusion and a groove formed in turn on both sides and an upper protruding bar and a lower protruding bar separated from each other formed to protrude in the installation space and moved up and down by adhering to a rotating sphere, and the rotating sphere eccentrically connected to a close point close to a center of the large bevel gear through an axis rotating in a state of adhering to the upper and lower protruding bar; An operation part, including a center rod installed in the case in a forward and backward direction and connected to a cable and installed with a welding rod, a pair of circular plates formed on the center rod located in the case while being separated from each other, and a saw-toothed wheel formed on each circular plate making the center rod rotate from side to side by being geared with the slider; wherein the weaving part further includes a front and rear reciprocating bar mounted in the mounting space and formed in a shape of “ [symbol] ”, and when the reciprocating adjustment handle provided on the case is operated, the front and back reciprocating bar descends in the mounting space, and the slider fixed to the weaving frame reciprocates forward and backward to exert a force on the pair of discs to reciprocate forward and backward of the center bar.

2. The welding rod holder in claim 1, wherein the front and rear reciprocating bars are formed such that both sides of the reciprocating bars are gradually tapered toward the lower side.

3. The welding rod holder in claim 2, wherein the case is provided with a reciprocating adjustment handle, and the reciprocating adjustment handle is connected to the front and rear reciprocating bar through wires having elastic springs at both ends thereof, and the amount of reciprocation of the center rod can be adjusted by adjusting the degree of the reciprocating bar being lowered.

4. A welding rod holder for easy weaving motion; a main body part comprising a case and a driving handle to drive the driving part; the driving part, installed in the case, including a driving motor, a small bevel gear rotating while being connected to a driving shaft of the driving motor, and a large bevel gear rotating at a reduced speed while being connected to the small bevel gear in a perpendicular direction; A weaving part, formed to be connected to the driving part including a weaving frame where an installation space is formed inside, a slider fixated by being connected to one plane of the weaving frame, a protrusion and a groove formed in turn on both sides and an upper protruding bar and a lower protruding bar separated from each other formed to protrude in the installation space and moved up and down by adhering to a rotating sphere, and the rotating sphere eccentrically connected to a close point close to a center of the large bevel gear through an axis rotating in a state of adhering to the upper and lower protruding bar; an operation part, including a center rod installed in the case in a forward and backward direction and connected to a cable and installed with a welding rod, a pair of circular plates formed on the center rod located in the case while being separated from each other, and a saw-toothed wheel formed on each circular plate making the center rod rotate from side to side by being geared with the slider; wherein the case is fixedly coupled to a support plate inside, and the support plate is provided between the slider and the center bar, and a slider is vertically movable while sliding on the base plate.

5. A welding rod holder for easy weaving motion; a main body part comprising a case and a driving handle to drive the driving part; the driving part, installed in the case, including a driving motor, a small bevel gear rotating while being connected to a driving shaft of the driving motor, and a large bevel gear rotating at a reduced speed while being connected to the small bevel gear in a perpendicular direction; A weaving part, formed to be connected to the driving part including a weaving frame where an installation space is formed inside, a slider fixated by being connected to one plane of the weaving frame, a protrusion and a groove formed in turn on both sides and an upper protruding bar and a lower protruding bar separated from each other formed to protrude in the installation space and moved up and down by adhering to a rotating sphere, and the rotating sphere eccentrically connected to a close point close to a center of the large bevel gear through an axis rotating in a state of adhering to the upper and lower protruding bar; An operation part, including a center rod installed in the case in a forward and backward direction and connected to a cable and installed with a welding rod, a pair of circular plates formed on the center rod located in the case while being separated from each other, and a saw-toothed wheel formed on each circular plate making the center rod rotate from side to side by being geared with the slider; wherein the case is designed such that a fixture clamp having a spring on the top thereof is exposed to the outside, and the lower end of the rounded portion is in contact with the middle portion of the center rod with the protruding portion and the groove portion alternately formed. When the above fixture clamp is depressed, the lower end of the rounded portion is in contact with the middle portion of the center rod, fixing the center rod.
